(19) United States
(12) Patent Application Publication
(10) Pub. No.: US 2023/0270218 A1
(43) Pub. Date: Aug. 31, 2023

(54) MAKEUP HOLDER DEVICE FOR CONNECTION WITH A CAR VISOR

(71) Applicant: Azure Scott, Stone Mountain, GA (US)

(72) Inventor: Azure Scott, Stone Mountain, GA (US)

(21) Appl. No.: 17/681,746

(22) Filed: Feb. 26, 2022

(51) Int. Cl. A45C 11/00; A45C 15/00; B60R 7/05

(52) U.S. Cl. CPC A45C 11/008; A45C 15/00; B60R 7/05

(57) ABSTRACT

A makeup holder for connection with a car visor is presented. The makeup hold has a container that has an outer surface, top portion a first fastener, a second fastener, a attachment mechanism and a bottom portion. The first fastener is configured to provide access to contents stored in the device. The bottom portion has a cavity and a surface. The surface further has one or more elastic first straps and one or more second straps, the elastic first straps and the elastic second straps are for holding the contents in place. The surface further has one or more pockets. The one or more pockets for holding the contents. The second fastener configured to allow access to the contents of the pockets. The attachment mechanism is coupled to the outer surface of the container and further coupled to the car visor.

### FIELD OF THE INVENTION

This invention relates to makeup holders. More particularly, it relates to connecting a makeup holder to a car visor or other objects.

### BACKGROUND

Cosmetics have been used by humans for at least 7,000 years and is present in almost every society on earth. Cosmetic body art is argued to have been the earliest form of a ritual in human culture. The evidence for this comes in the form of utilized red mineral pigments (red ochre) including crayons associated with the emergence of Homo sapiens in Africa. Cosmetics are mentioned in the Old Testament 2 Kings 9:30 where Jezebel painted her eyelids in approximately 840 BC.

In 2005, the market volume of the cosmetics industry in the US, Europe, and Japan was about $79,241,540,000 a year, showing the popularity of cosmetics. Cosmetics, however, if not stored properly, can create a mess of their environment.

Karl Benz was granted a patent for the automobile on Jan. 29, 1886. In the time since its invention, automobiles have grown in popularity to the point that there are an estimated 1 billion cars, or one car for every eight people worldwide.

There are not currently any storage containers made for holding cosmetics in an automobile. Cosmetic containers made for automobiles must, in necessity, securely organize, hold, and protect cosmetics from a number of hazards. Heat, light, and moisture are destructive to many cosmetics.

Accordingly, and in light of the foregoing, there is a need for a device that can attach and secure a cosmetics container to a visor or other like apparatus for safe and easy use. It is also desirable for said device to be lightweight and cost effective.

### BRIEF DESCRIPTION OF THE DRAWINGS

These and other features, aspects, and advantages of the present disclosure will become better understood with regard to the following description, appended claims, and accompanying drawings where:

FIG. 1 is a perspective view of the makeup holder 10, according to an embodiment of this disclosure;

FIG. 2 is a top view of the makeup holder 10, according to an embodiment of this disclosure;

FIG. 3 is a bottom view of the makeup holder 10, according to an embodiment of this disclosure;

FIG. 4 is a side perspective view of the makeup holder 10, according to an embodiment of this disclosure; and,

FIG. 5 is an environmental view of the makeup holder 10 in use, according to an embodiment of this disclosure.

### DESCRIPTIVE KEY

10 makeup holder
12 container
13 first fastener
14 top portion
16 bottom portion
18 cavity
20 surface
22 first strap
23 second strap
24 pocket
25 second fastener
28 mirror
30 attachment mechanism
35 illumination means
36 illumination ray
L length
W width
V visor

### DETAILED DESCRIPTION

The following disclosure is provided to describe various embodiments of a makeup holder 10 for connection with a car visor V. Skilled artisans will appreciate additional embodiments and uses of the present invention that extend beyond the examples of this disclosure. Terms included by any claim that may be presented in any yet-to-be-filed non-provisional patent application are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one (1) of A, B, and C” should be read to permit any of A, B, or C singularly or in combination with the remaining elements. Additionally, such groups may include multiple instances of one (1) or more element in that group, which may be included with other elements of the group. All numbers, measurements, and values are given as approximations unless expressly stated otherwise.

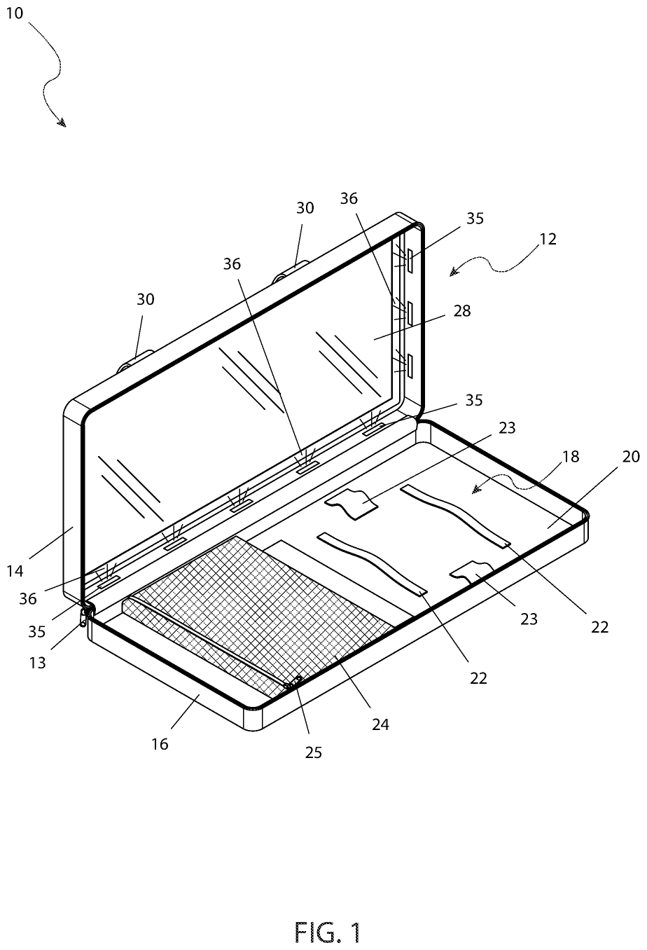

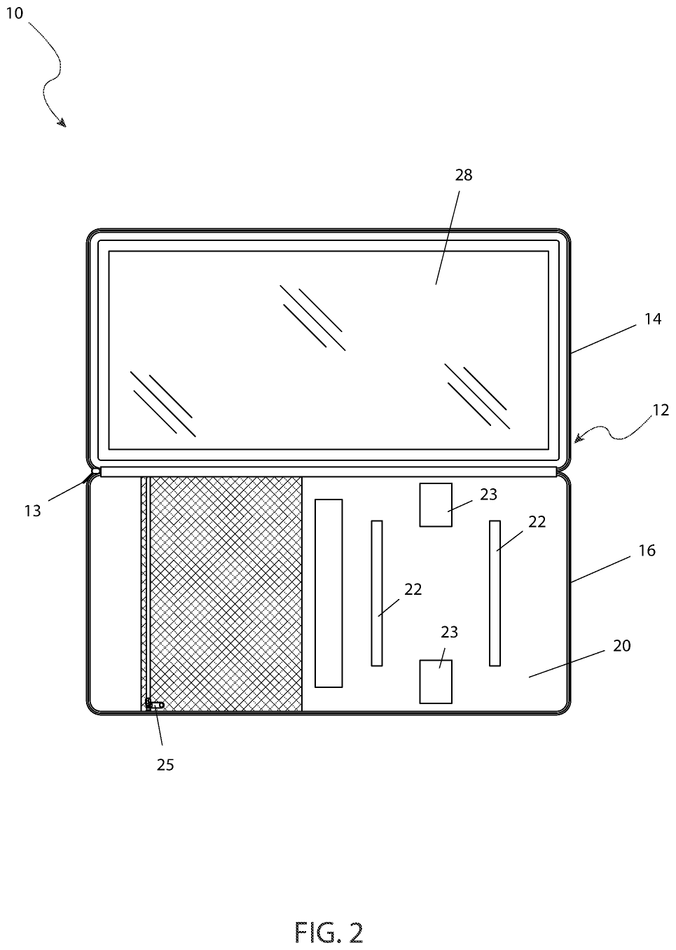

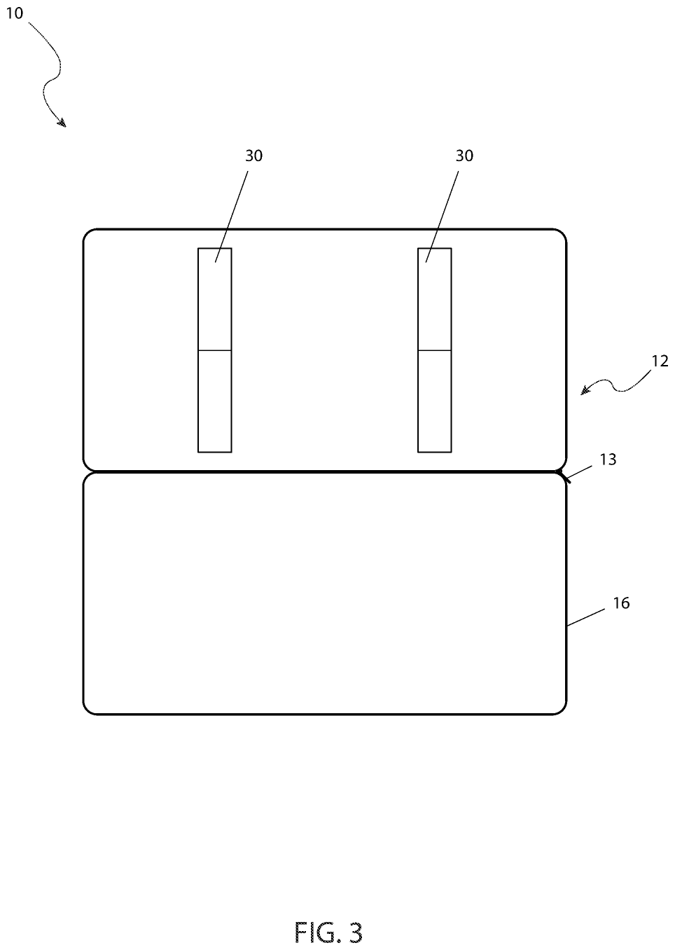

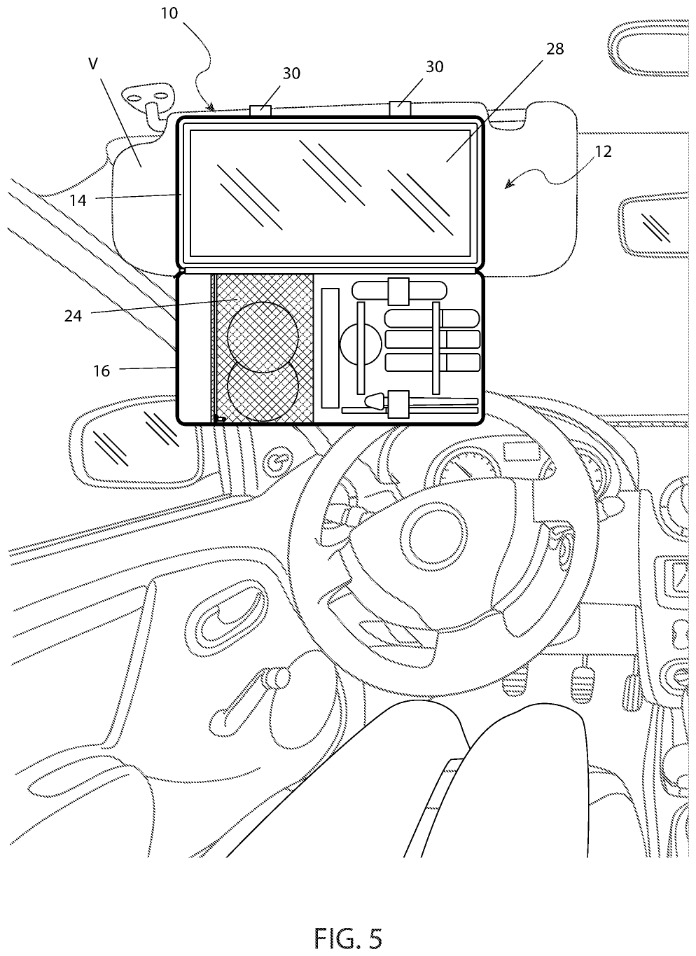

Various aspects of the present disclosure will now be described in detail, without limitation. Skilled readers should not view the inclusion of any alternative labels as limiting in any way. Referring now to FIGS. 1-5, an illustrative makeup holder (herein described as the “device”) 10 will now be discussed in more detail.

The device 10 includes a container 12. In some embodiments, the container 12 includes a top portion 14 and a bottom portion 16. In some embodiments, the container 12 includes a first fastener 13 for providing access to the contents intended to be stored within the device 10. In certain embodiments, the first fastener 13 is a zipper track that mates leading edges of the top portion 14 to the bottom portion 16 to seal the contents therewithin.

In some embodiments, the bottom portion 16 includes a cavity 18 configured to hold makeup, as described herein. The cavity 18 may be of any volume size so as to hold different sizes of makeup therein. In some embodiments, the container 12 includes a heat-resistant material configured to resist and/or prevent the makeup contents from melting during hot weather. In some embodiments, the container 12 includes a metal or a plastic material and may include a layer of insulation to facilitate avoiding melting of the makeup contents. For example, the container 12 may include an aluminum casing having a thermal insulated liner. In some embodiments, the container 12 may include a battery or solar operated cooling system. In some embodiments, the container 12 may include a suede-lined bag for cooling makeup contents.

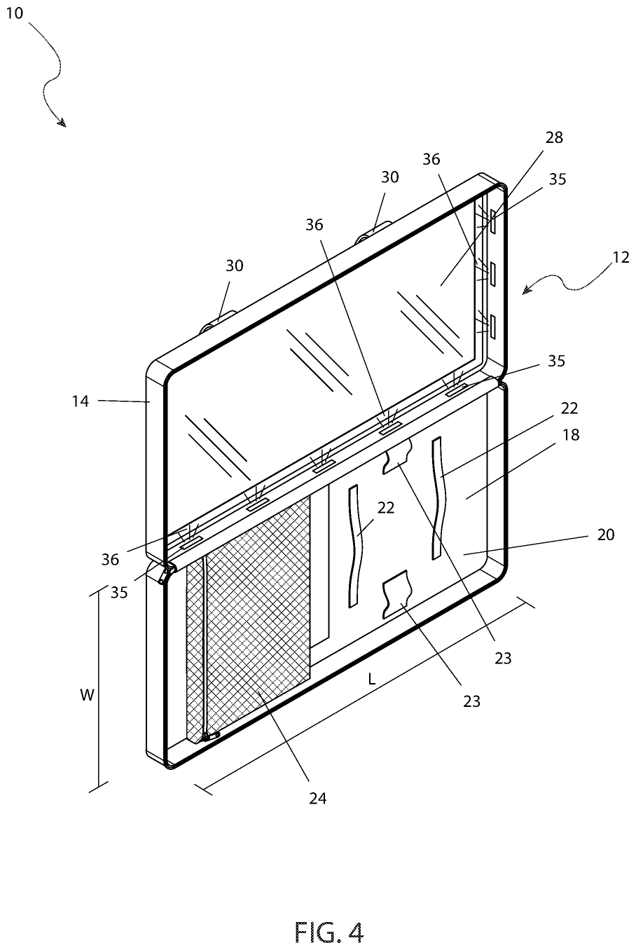

In some embodiments, the container 12 includes a length L and a width W, as shown in FIG. 4. In some embodiments, length L is approximately nine inches (9 in.). In some embodiments, width W is approximately four and one-half inches (4-1/2 in.).

The bottom portion 16 further includes a surface 20 having one (1) or a plurality of elastic first straps 22 configured to hold makeup contents in place, as well as having one (1) or a plurality of elastic second straps 23 configured to hold makeup contents in place. The first straps 22 can be smaller in width and longer in length than the second straps 23. In some embodiments, the first straps 22 are oriented along a first axis and the second straps 23 are oriented along a second axis, which in a preferred embodiment can be perpendicular thereto. The first straps 22 and second straps 23 prevent makeup contents from shifting within container 12 during movement of the car. In some embodiments, the surface 20 includes one (1) or a plurality of pockets 24 to hold other makeup contents. Such a pocket 24 is located adjacent to the first straps 22 and second straps 23. In some embodiments, the pocket 24 may be a tight-mesh-like material so the contents can be easily visible. In other embodiments, a second fastener 35 may provide access to the contents within the pocket 24. Such a second fastener 25 can also be a zipper track.

In some embodiments, the top portion 14 is also configured to hold makeup contents. Such a volume size of the top portion 14 may be coextensive with, or slightly smaller or slightly larger than the volume size of the cavity 18 of the bottom portion 16. In some embodiments, the top portion 14 also includes an inner surface having one (1) or a plurality of elastic first straps 22 or one (1) or a plurality of second straps 23 configured to hold makeup contents in place. In some embodiments, the top portion 14 includes a mirror 28. In some embodiments, the mirror 28 and any straps 22, 23 may be present. In some embodiments, the mirror 28 is a magnifying mirror. In other embodiments, there exists at least one (1) illumination means 35 mounted to or embedded within the inner perimeter frame or portion of the top portion 14. The illumination means 35 may direct illumination rays 36 towards a central point, preferably at the mirror 28.

The container 12 includes a rectangular shape configured to attach to a car window visor V. In some embodiments, the container 12 may include various shapes, for example, oval, oblong, triangular, square, polygonal, irregular, uniform, non-uniform, variable, and/or tapered. The container 12 can further include at least one (1) attachment mechanism 30 configured to attach container 12 with visor V. In some embodiments, the attachment mechanism 30 may include hook-and-loop straps, hooks, knots, integral connection, friction fit, pressure fit, mating engagement, dovetail connection, tongue in groove, threaded, clamp, and/or key/keyslot. In other embodiments, the attachment mechanism 30 can be attached to or integral with an outer surface of either the top portion 14 or the bottom portion 16 of the container 20.

In operation, the container 12 is connected with the visor V via the attachment mechanisms 30. The user flips the visor V down for access to the container 12. Any desired of makeup contents can be stowed in the first straps 22, second straps, 23 or pocket 24. Access to the contents can be achieved by opening the first fastener 13. Access to the contents in the pocket 24, if so stowed, can be achieved by opening the second fastener 25. After use, the container 12 can be closed via the first fastener 13 and remains in place underneath the visor V when flipped back up. Other methods of use envision the container 12 to be connected with any similar support structure, such as a back of a chair, a head rest in a vehicle, etc., via the attachment mechanism 30.

While various aspects of the present invention have been described in the above disclosure, the description of this disclosure is intended to illustrate and not limit the scope of the invention. Skilled artisans will appreciate additional aspects of the invention, which may be realized in alternative embodiments, after having the benefit of the above disclosure. Other aspects, advantages, embodiments, and modifications are within the scope of the claims.

What is claimed is:

1. A makeup holder device for connection with a car visor, the device comprising:
a container, the container comprising:
an outer surface;
a top portion, a bottom portion, a first fastener, wherein the first fastener is configured to provide access to contents stored in the device;
a bottom portion, the bottom portion having a cavity, a surface, the surface further having one or more elastic first straps and one or more second straps, the elastic first straps and the elastic second straps being for holding the contents in place;
the surface further having one or more pockets wherein the one or more pockets for holding the contents, wherein the one or more pockets configured to be adjacent to the first straps and the second straps, the pockets having a second fastener, wherein the second fastener configured to allow access to the contents of the pockets; and
at least one attachment mechanisms, the attachment mechanisms being coupled to the outer surface of the container and further coupled to the car visor.

2. The device according to claim 1, wherein the container may be any size volume.

3. The device according to claim 1, wherein the container being configured to hold any size contents.

4. The device according to claim 1, wherein the container being made of a heat resistant material.

5. The device according to claim 1, wherein the container being made of a plastic material and a layer of insulation.

6. The device according to claim 1, wherein the container being made of aluminum wherein the aluminum being configured to be a thermal insulation liner.

7. The device according to claim 1, wherein the container further comprising: a cooling system, wherein the cooling system having one of a battery or solar power power source.

8. The device according to claim 1, wherein the container having a length of nine inches (9″).

9. The device according to claim 1, wherein the container having a width of four and one-half inches (4.5″).

10. The device according to claim 1, wherein the container further comprising a fur-lined bag, wherein the fur lined bag being for storing contents.

11. The device according to claim 1, wherein the first straps configured to be oriented along a first axis and the second straps configured to be oriented along a second axis.

12. The device according to claim 1, wherein the pockets being made of a mesh material.

13. The device according to claim 1, wherein the second fastener being a zipper track.

14. The device according to claim 1, wherein the container having a rectangular shape.

15. The device according to claim 1, wherein the container having an oblong shape.

16. The device according to claim 1, wherein the attachment mechanism being a hook and loop strap.

17. The device according to claim 1, wherein the attachment mechanism being a mating engagement.

18. The device according to claim 1, wherein the device being coupled to a back of a chair.

19. The device according to claim 1, wherein the device being coupled to a head-rest in a vehicle.
